(19) United States
(12) Patent Application Publication
(10) Pub. No.: US 2013/0070462 A1
(43) Pub. Date: Mar. 21, 2013

(54) REFLECTIVE LIGHTING DEVICE

(71) Applicants: Xiao Ming Jin, Bangkok (TH); Tao Jin, Xian City (CN); Henry Lam, Narwee (AU)

(72) Inventors: Xiao Ming Jin, Bangkok (TH); Tao Jin, Xian City (CN); Henry Lam, Narwee (AU)

(73) Assignees: Xiao Ming Jin, Bangkok (TH); Henry Lam, Narwee (AU); Tao Jin, Xian City (CN)

(21) Appl. No.: 13/233,690

(22) Filed: Sep. 15, 2011

(51) Int. Cl. F21V 7/00; F21V 7/04

(52) U.S. Cl. 362/298; 362/296.05

(57) ABSTRACT

A reflection lighting device comprises a reflective member including a reflective plate and a reflective mirror plate, and a supporting member to support the reflective member. A light-emitting member is provided between the reflective plate and the reflective mirror plate. The other reflection lighting device comprises a reflective member provided with a trough shape, and a double-sided mirror arranged within the reflective member. A light-emitting member is provided within the reflective member. And if the light-emitting member is triangular-prism-shaped, the reflection area of that is larger in the same length or the same weight condition, and the angle of the reflection surface of that is more selective, while comparing to the circular-cylinder-shaped light-emitting member which is commonly used now. Therefore, the efficiency, the intensity, and the range of the illumination increase so that the energy may be more saved.

### FIELD OF THE INVENTION

The present invention relates to a lighting device, and more particularly to a reflective lighting device.

### BACKGROUND OF THE INVENTION

Nowadays, the irradiation of the light emitted from the lighting device used in various places is mostly unidirectional. Therefore, there are limitations for increasing the utilization rate of the light source and for improving the efficacy of the lighting. In order to satisfy the users about the requirement of the intensity of the illumination, it is common to increase the installation quantity of the lighting device. It thus not only increases the cost expense for installation of the light device, but also it is more power consumption since it requires to use a higher voltage power. It further causes more unsafe factors which may cause the damage and then may result in the power failure in wide regions. Furthermore, since the maximum reflection area of the conventional cylinder lamp tub is limited by the area of curved side surface thereof, it becomes an important issue regarding how to enlarge the reflection area of the lamp tub to enhance the efficacy of light based on a lamp tub with the same length and weight.

### SUMMARY OF THE INVENTION

The conventional lighting device has its limitations in efficacy of light and is energy waste. And it is necessary to use higher voltage power to cause more unsafe factors when transmitting the power.

Thereby, an object of the present invention is to provide a reflective lighting device that overcomes the defects existing in the prior arts by increasing the efficacy of lighting so as to save the energy.

The present invention overcomes the drawbacks of the prior art, and provides a reflective lighting device, which comprises a light-emitting member, a reflective member and a supporting member, wherein the reflective member includes a reflective plate and a reflective mirror plate, the reflective plate and the reflective mirror plate providing on the supporting member are oppositely facing to each other, and the light-emitting member is provided between the reflective plate and the reflective mirror plate.

In a preferred embodiment of the present invention, it further comprises a plurality of reflective mirrors provided on the reflective plate and/or on the reflective mirror plate.

In a preferred embodiment of the present invention, it further comprises a magnifying glass provided on the reflective mirror plate.

In a preferred embodiment of the present invention, it further comprises a transparent plate extending outward from the reflective mirror plate.

In a preferred embodiment of the present invention, it further comprises a subsidiary plate provided on the reflective plate.

In a preferred embodiment of the present invention, the subsidiary plate has a reflective part and/or a transparent part.

In a preferred embodiment of the present invention, the supporting member is a transparent cover.

Furthermore, in another preferred embodiment, the present invention overcomes the drawbacks of the prior art, and provides a reflective lighting device, which comprises a light-emitting member and a reflective member, wherein the reflective member is provided with a trough shape, the light-emitting member is provided within the reflective member, and a double-sided mirror is arranged within the reflective member.

In another preferred embodiment of the present invention, the double-sided mirror is provided with a punching hole thereon for allowing the light-emitting member to pass through, and a rubber ring is put around the punching hole.

In another preferred embodiment of the present invention, it further comprises a plurality of reflective mirrors provided on the reflective member.

In another preferred embodiment of the present invention, it further comprises a subsidiary plate, which is provided on the reflective member and has a reflective part and/or a transparent part.

In another preferred embodiment of the present invention, a light of a specific wavelength can pass through the reflective member, or the reflective member has a transparent part.

In another preferred embodiment of the present invention, it further comprises a waterproof transparent cover covering the reflective member.

In another preferred embodiment of the present invention, the reflective member is a V-shaped configuration or a triangular-prism-shaped configuration.

In another preferred embodiment of the present invention, the light-emitting member has a reflective part and/or a transparent part.

In another preferred embodiment of the present invention, it further comprises an emission lamp provided on the two ends of the light-emitting member.

In another preferred embodiment of the present invention, the emission lamp has a reflective part.

In another preferred embodiment of the present invention, the emission lamp is a polyhedron-shaped configuration.

Furthermore, in another preferred embodiment, the present invention overcomes the drawbacks of the prior art, and provides a reflective lighting device, which comprises a light-emitting member and a reflective member, the reflective member is provided with a trough shape, and the light-emitting member is provided within the reflective member, wherein the light-emitting member is a triangular-prism-shaped configuration, and an electrical connector is provided on the light-emitting member.

In another preferred embodiment of the present invention, a light of a specific wavelength can pass through the surface of the light-emitting member or be reflected from the surface of the light-emitting member, wherein the light-emitting member optionally has a reflective part and/or a transparent part.

In another preferred embodiment of the present invention, the light-emitting member is a LED light, an incandescent light, or a fluorescent light.

The light-emitting member is provided between the reflective plate and the reflective mirror. It makes the reflection of the light source become multiple reflections between the reflective plate and the reflective mirror so as to increase the brightness and the range of the illumination.

The light-emitting member passes though the double-sided mirror and is also provided among the reflective member, wherein the light-emitting member and the reflective member are in parallel with each other. The light emitted form the light source is reflected several times to become the multiple light images by the reflective member and the double-sided mirror. And the rubber ring provided on the punching hole of the double-sided mirror, which the light-emitting member passes though, is helpful for light-emitting member to be prevented from being shocked.

The surface of the triangular-prism-shaped light-emitting member is different from the surface of the conventional lamp which is circular-cylinder-shaped in the same length or the same weight condition. And the advantage of the triangular-prism-shaped light-emitting member is: It may provide the light source to be emitted with various angle because the angle of the triangular prism may be designed to be various types; The area of the surface of the triangular prism is large than that of the circular cylinder in the same cross-sectional area condition, so that the reflection area of the triangular-prism-shaped light-emitting member is larger than that of the conventional circular-cylinder-shaped lamp in the same length or the same weight condition. The increase of the reflection area also means that the efficacy of the lighting increases.

This present disclosure increases the efficacy of the lighting by increasing the reflection area so that the energy may be saved. Thereby, because of the lower energy consumption, the power source of the reflective lighting device is suitable for being supplied from the solar power device and also is able not to be transmitted with high voltage which may cause the damage and then may result in the power failure and the cost in wide regions. And particularly, the LED light is suitable for being used as the point light source of the reflective lighting device. Since the light emitted for the point-style light sources in the reflective lighting device are reflected several times to become the multiple light images, the brightness and the illumination area both increase.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating the first embodiment according to the present invention;

FIG. 2 is a perspective view illustrating the reflective plate of the first embodiment according to the present invention;

FIG. 3 is a perspective view illustrating the reflective mirror plate of the first embodiment according to the present invention;

FIG. 4 is a perspective view illustrating the second embodiment according to the present invention;

FIG. 5 is a perspective view illustrating the reflective mirror plate of the second embodiment according to the present invention;

FIG. 6 is a perspective view illustrating the third embodiment according to the present invention;

FIG. 7 is a perspective view illustrating the fourth embodiment according to the present invention;

FIG. 8 is a perspective view illustrating the distribution of the light source of the fourth embodiment according to the present invention;

FIG. 9 is a perspective view illustrating the fifth embodiment according to the present invention;

FIG. 10 is a perspective view illustrating the sixth embodiment according to the present invention;

FIG. 11 is a perspective view illustrating the seventh embodiment according to the present invention;

FIG. 12 is a perspective view illustrating the eighth embodiment according to the present invention;

FIG. 13A is a perspective view illustrating the ninth embodiment according to the present invention;

FIG. 13B is a partial view illustrating the ninth embodiment according to the present invention;

FIG. 14A is a perspective view illustrating the tenth embodiment according to the present invention;

FIG. 14B is a sectional perspective view illustrating the A-A direction of the tenth embodiment according to the present invention.

### DETAILED DESCRIPTION OF THE PREFERRED EMBODIMENTS

### The First Embodiment

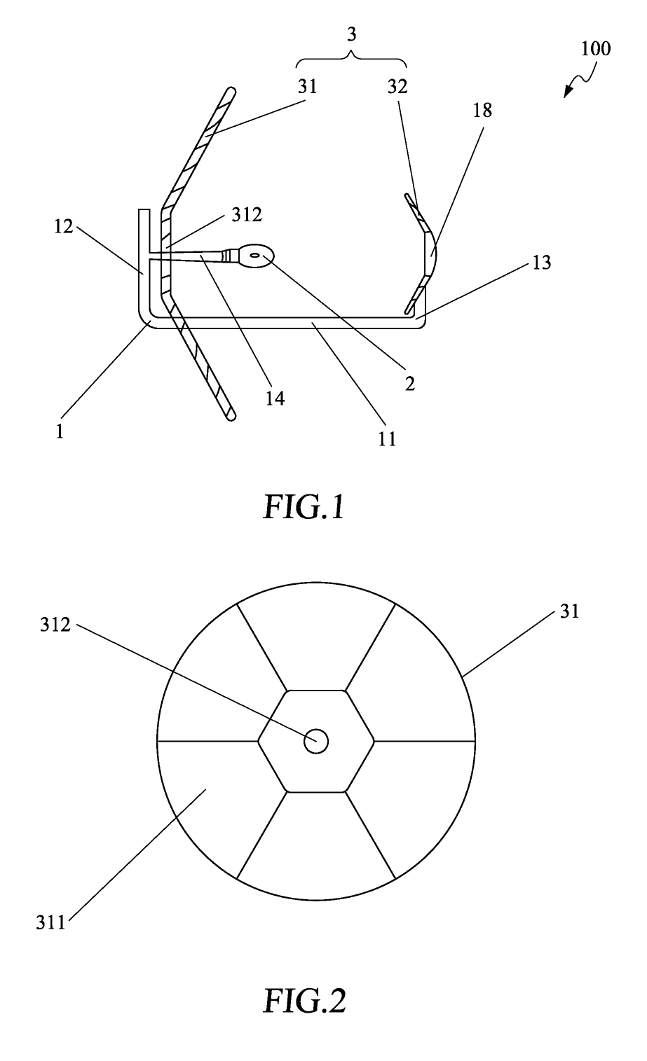

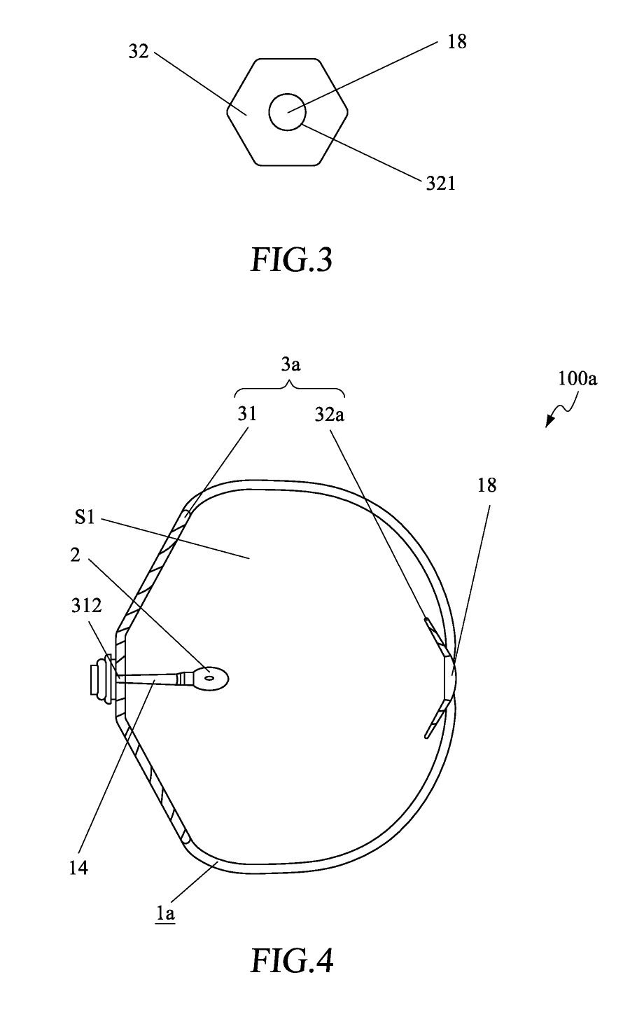

A reflective lighting device 100 of the present invention is shown in FIG. 1. A reflective plate of the reflective lighting device 100 is shown in FIG. 2. A reflective mirror plate of the reflective lighting device 100 is shown in FIG. 3. The reflective lighting device 100 comprises a supporting member 1, a light-emitting member 2, and a reflective member 3. The reflective member 3 includes a reflective plate 31 and a reflective mirror plate 32. The reflective plate 31 and the reflective mirror plate 32 are both provided on the supporting member 1. And the reflective plate 31 and the reflective mirror plate 32 face oppositely to each other. The light-emitting member 2 is disposed between the reflective plate 31 and the reflective mirror plate 32.

The supporting member 1 includes a primary rod 11, a first branch rod 12, a second branch rod 13, and a light rod 14. The first branch rod 12 and the second branch rod 13 are provided on the two ends of the primary rod 11 respectively. The light rod 14 is disposed on the first branch rod 12.

As shown in FIG. 2, the reflective plate 31 includes a plurality of the reflective mirrors 311, and in the central of the reflective plate 31 there is a central aperture 312 for light rod 14 to pass through. As shown in FIG. 3, an aperture 321 is formed on the central of the reflective mirror plate 32, and a magnifying glass 18 is disposed on the edge of the aperture 321. The magnifying glass 18 may be fixed on the edge of the aperture 321 by interlocking.

Refer again to FIG. 1, the light rod 14 passes through the central aperture 312 of the reflective plate 31. The reflective mirror plate 32 is fixed on the end of the second branch rod 13 of the supporting member 1. The light-emitting member 2 is disposed on the end of the light rod 14.

In this embodiment, the light-emitting member 2 is a LED lamp, and light-emitting member 2 may also be an incandescent lamp, a fluorescent lamp or a lamp with a cover covering the LED lamp or the incandescent lamp.

The streams of the light emitted from the light-emitting member 2 are not only refracted outward by the plurality of the reflective mirrors 311 on the reflective plate 31, but also are focused by the magnifying glass 18 and pass through the magnifying glass 18 then illuminate forward of the magnifying glass 18. The other streams of the light emitted from the light-emitting member 2 which have not pass through the magnifying glass 18 are reflected repeatedly between the reflective plate 31 and the reflective mirror plate 32 and then illuminate outward to enhance the efficacy of the light emitted from the light-emitting member 2.

### The Second Embodiment

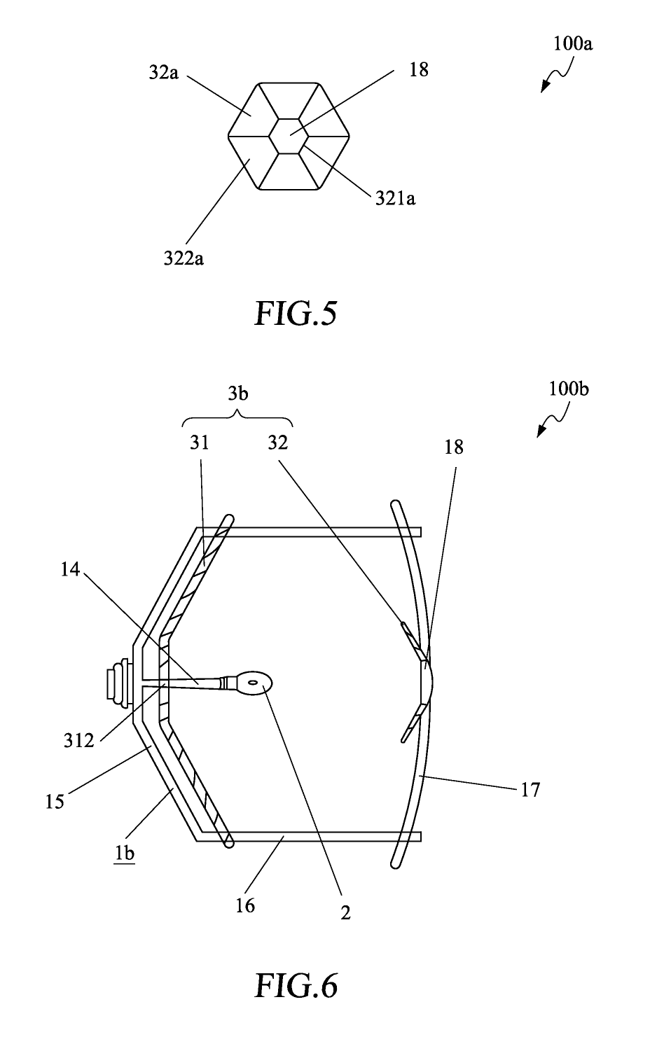

A reflective lighting device 100a of the present invention is shown in FIG. 4. A reflective mirror plate of the reflective lighting device 100a is shown in FIG. 5. The elements of this embodiment illustrated in these two Figs. are similar to those in the first embodiment. The second embodiment is different from the first embodiment in as follows. The supporting member 1a is a transparent cover. The reflective plate 31 and the reflective mirror plate 32a are provided on the two ends of the supporting member 1a respectively. The reflective mirror plate 32a includes a plurality of the reflective mirrors 322a, and a magnifying glass 18 is disposed on the edge of the aperture 321a of the reflective mirror plate 32a. The magnifying glass 18 may be fixed on the edge of the aperture 321a by interlocking. And the connection between the supporting member 1a, reflective plate 31, and the reflective mirror plate 32a is sealed and waterproof so as to form a sealed space S1. In this embodiment, the shape of the supporting member 1a is bucket-shaped and has a opening to joint the reflective plate 31 and the reflective mirror plate 32a, and the supporting member 1a also may be a cube-shaped configuration with a opening, or the like. The light rod 14 is inserted into the sealed space S1 through the central aperture 312 of the reflective plate 31.

The illumination style of the light-emitting member 2 of this embodiment is similar to the one in the first embodiment. The second embodiment is different from the first embodiment in as follows. In addition to the streams of the light focused by the magnifying glass 18 and then pass forward through the magnifying glass 18, the other streams of the light refracted by the reflective plate 31 and the reflective mirror plate 32a all pass outward through the supporting member 1a. And since the reflective lighting device 100a is sealed and waterproof, it is suitable to be used outside or in the moist environment.

### The Third Embodiment

A reflective lighting device 100b of the present invention is shown in FIG. 6. The elements of this embodiment illustrated in the Fig. are similar to those in the first embodiment. The third embodiment is different from the first embodiment in as follows. The reflective lighting device 100b further includes a bottom plate 15 for light rod 14 of the supporting member 1b to be disposed thereon, a plurality of the third branch rods 16 spaced at intervals and surrounding around the bottom plate 15, and a transparent plate 17 extending from the reflective mirror plate 32 and disposed on the ends of the plurality of the third branch rods 16. The reflective plate 31 is provided on the bottom plate 15 of the supporting member 1b, and the light rod 14 is inserted in the central aperture 312 of the reflective plate 31.

The illumination style of the light-emitting member 2 of this embodiment is similar to the one in the first embodiment. The third embodiment is different from the first embodiment in as follows. The transparent plate 17 is disposed in the front of the reflective plate 31 so as to prevent from the discomfort due to the direct illumination emitted by the light-emitting member 2.

### The Fourth Embodiment

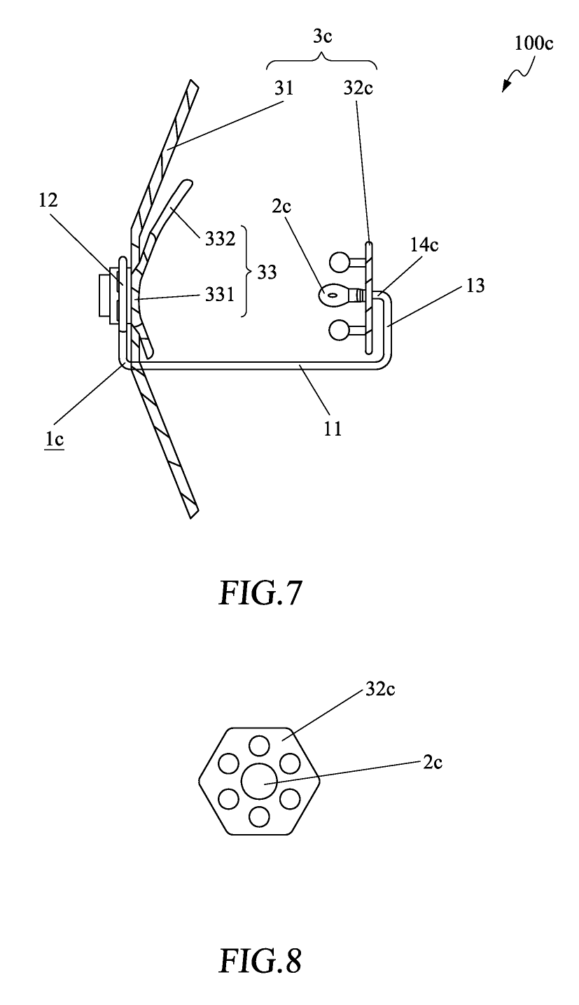

A reflective lighting device 100c of the present invention is shown in FIG. 7. The distribution of the light source of the reflective lighting device 100c is shown in FIG. 8. The elements of this embodiment illustrated in these two Figs. are similar to those in the first embodiment. The fourth embodiment is different from the first embodiment in as follows. A subsidiary plate 33 is provided on the central of the reflective plate 31. The subsidiary plate 33 has a reflective part 331 for reflecting the light and has a transparent part 332 for the light passing, wherein the transparent part 332 is a flat lens, a convex lens, or a concave lens. The subsidiary plat 33 may be some types of the plat as follows. The streams of the light of a specific wavelength can pass through or be reflected form the subsidiary plat 33; The subsidiary plate 33 may be a transparent plate or a reflective plate, wherein the reflective plate may be the flat transparent plate, the convex transparent plate, and the concave transparent plate. A light rod 14c parallel to the primary rod 11 is provided on the end of the second branch rod 13. A reflective mirror plate 32c is provided on the end of the light rod 14c. And the lights are emitted from a plurality of the light-emitting members 2c (as shown in FIG. 8). The advantage of the illumination of this embodiment is: If the subsidiary plate 33 is a reflective plate, the light emitted form a plurality of the light-emitting members 2c which are light sources may all be reflected from the subsidiary plate 33 to the reflective mirror plate 32c, and then be reflected from the reflective mirror plate 32c to the reflective plate 31, and then reflected outward from the reflective plate 31 finally. It makes the light emitted form the light-emitting member 2c being reflected three times so as to enhance the efficacy of the light emitted from the light sources. The transparent part 332 of the subsidiary plate 33 can change the focal length of the light emitted from the light-emitting member 2c or of the light reflected from the reflective mirror plate 32c to the reflective plate 31, so as to change the efficacy of the light reflected form the reflective plate 31.

### The Fifth Embodiment

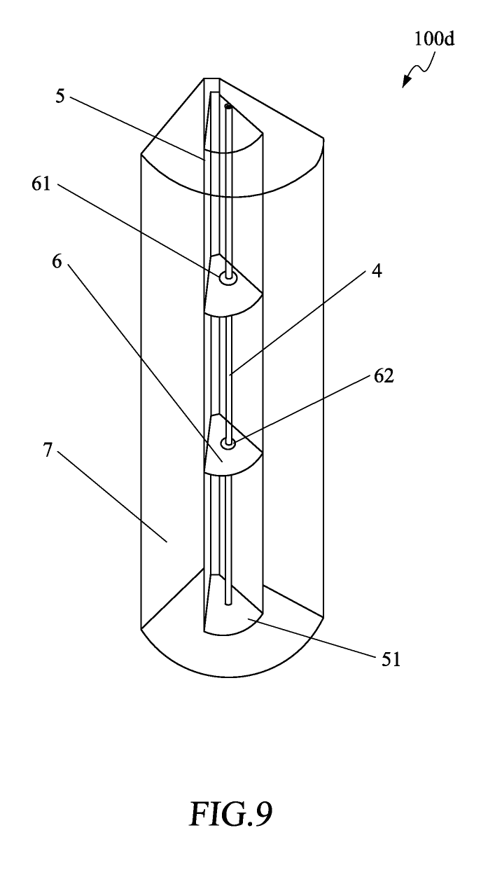

A reflective lighting device 100d of the present invention is shown in FIG. 9. In this embodiment, the reflective lighting device 100d comprises a light-emitting member 4 and a reflective member 5, wherein the reflective member 5 is provided with a trough shape and can be passed through by a light of a specific wavelength. The light-emitting member 4 is arranged within the reflective member 5. A light of a specific wavelength can pass through the surface of the light-emitting member 4, and the surface of the light-emitting member 4 can reflect a light of another specific wavelength outside. Moreover, a double-sided mirror 6 is provided within the reflective member 5, and a seal board 51 with reflective mirror at single side is provided on the two ends the reflective member 5. A punching hole 61 is formed on the double-sided mirror 6 for the light-emitting member 4 passing through, wherein a rubber ring 62 is provided on the edge of the punching hole 61. The rubber ring 62 is able to fix the light-emitting member 4 and also prevent the light-emitting member 4 from being shocked. Furthermore, a waterproof transparent cover 7 covers the reflective member 5.

In this embodiment, the light-emitting member 4 is a fluorescent lamp. The light-emitting member 4 may also have a cover covering a light-emitting element, wherein the light-emitting element may be a LED lamp or an incandescent lamp. The reflective member 5 is a strip-ladder-shaped trough. However, the reflective member 5 may be any configuration of which the shape is adapted to the light-emitting member 4.

### The Sixth Embodiment

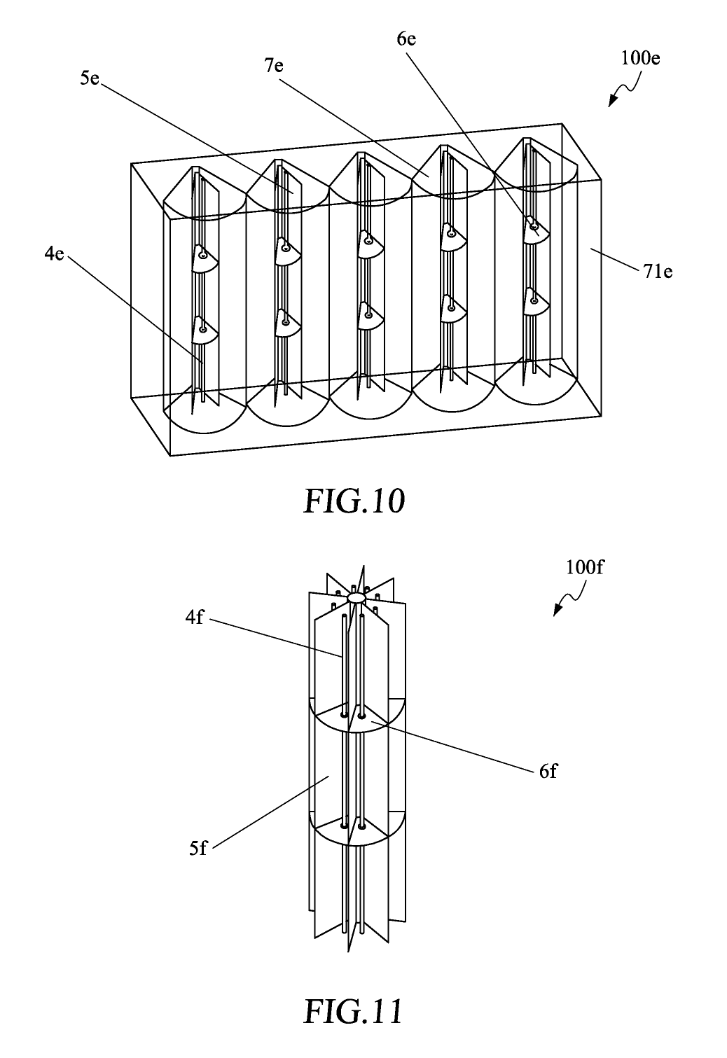

Refer to FIG. 10 and refer again to FIG. 9. FIG. 10 shows a reflective lighting device 100e of the present invention. The reflective light device 100e is composed of a plurality of the members similar to the members of the reflective lighting device 100d, such as a light-emitting member 4e, a reflective member 5e, a double-sided mirror 6e, a waterproof transparent cover 7e (the seal board 51 with reflective mirror at single side excludes) in a row within a transparent box 71e. The reflective lighting device 100e may be used as an advertisement lighting box.

### The Seventh Embodiment

Refer to FIG. 11 and refer again to FIG. 9. FIG. 11 shows a reflective lighting device 100f of the present invention. The reflective lighting device 100f is composed of a plurality of the members similar to the members of the reflective lighting device 100d, such as a light-emitting member 4f, a reflective member 5f, a double-sided mirror 6f (the seal board 51 with reflective mirror at single side and the waterproof transparent cover 7 exclude) in a circle. The reflective lighting device 100f can be used as a lamppost of which the irradiant angle is 360°. And the efficacy of the light source of the light-emitting member 4f is multiplied due to be reflected by the reflective member 5f and double-sided mirror 6f.

### The Eighth Embodiment

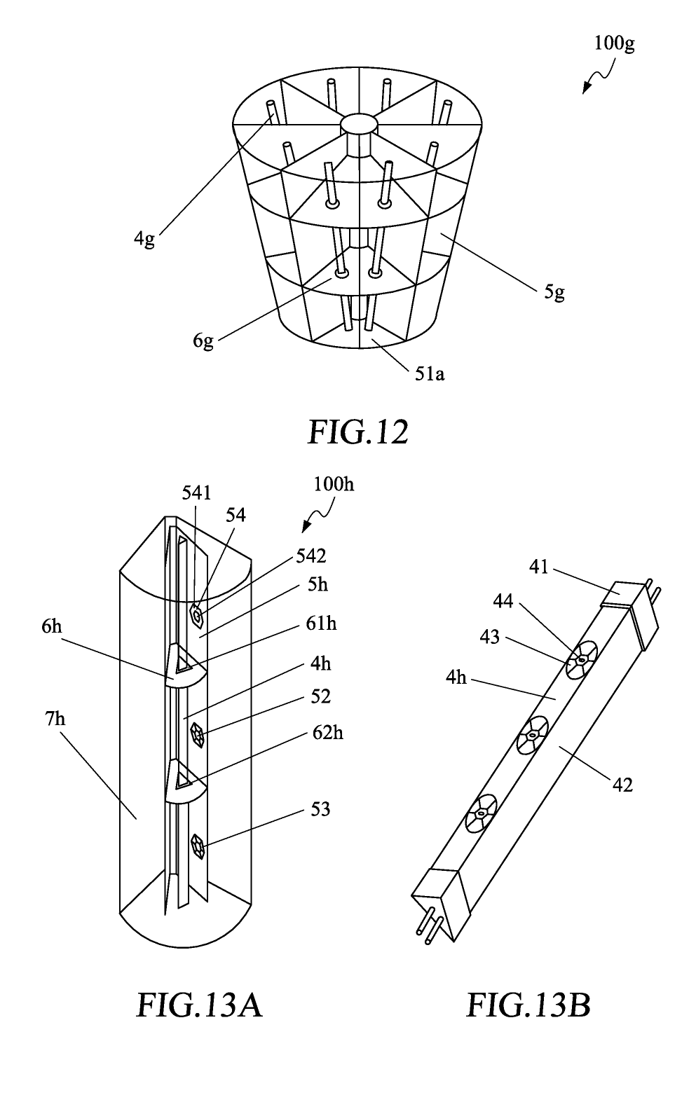

Refer to FIG. 12 and refer again to FIG. 9. FIG. 12 shows a reflective lighting device 100g of the present invention. The reflective lighting device 100g is composed of a plurality of the members similar to the members of the reflective lighting device 100d, such as a light-emitting member 4g, a reflective member 5g, a double-sided mirror 6g (the seal board 51 with reflective mirror at single side and the waterproof transparent cover 7 exclude) in a circle, and the light-emitting member 4g and the double-sided mirror 6g have a downward tilt to the horizontal surface. The reflective lighting device 100g can be used as a lamppost of which the irradiant angle is 360° and downward.

### The Ninth Embodiment

Refer to FIGS. 13A and 13B. A reflective lighting device 100h of the present invention is shown in FIG. 13A. And FIG. 13B shows a partial view of the reflective lighting device 100h. The elements of this embodiment illustrated in these two Figs. are similar to those in the fifth embodiment. The ninth embodiment is different from the fifth embodiment in as follows. The light-emitting member 4h is triangular-prism-shaped, and an electrical connector 41 is provided on the light-emitting member 4h. The light-emitting member 4h passes through the punching hole 61h which is triangular-prism-shaped. And a rubber ring 61h is put on the punching hole 61h, wherein the punching hole 61h is also triangular-prism-shaped for fixing the light-emitting member 4h and preventing the light-emitting member 4h from being shocked.

As shown in FIG. 13B. In this embodiment, the electrical connector 41 is provided on the two ends of the light-emitting member 4h. A light of a specific wavelength can pass through the surface of the light-emitting member 4h, and the surface of the light-emitting member 4h can reflect a light of another specific wavelength outside. The light-emitting member 4h has a transparent part 42 for the light passing and has a reflective part 43 to reflect the light. The reflect member 5h has a transparent part 52 for the light passing. In this embodiment, the transparent part 42 is a transparent cover covering a LED lamp 44, wherein the light emitted from the LED lamp 44 can pass through the transparent part 42. And light-emitting member 4h also may be an incandescent lamp or a fluorescent lamp. In this embodiment, the reflective part 43 is a plurality of the reflective mirrors which surrounds the LED 44 and is provided on the outer surface of the light-emitting member 4h. A plurality of the reflective mirrors 53 is provided on the reflective member 5h and surrounds the transparent part 52. The transparent part 52 may be a transparent lens or the like. A subsidiary plate 54 has a reflective part 541 to reflect the light and has a transparent part 542 for the light passing, wherein the transparent part 542 is a flat lens, a convex lens, or a concave lens. The subsidiary plat 54 may be some types of the plat as follows. The streams of the light of a specific wavelength can pass through or be reflected form the subsidiary plate 54; the subsidiary plate 54 may be a transparent plate or a reflective plate, wherein the transparent plate may be the flat transparent plate, the convex transparent plate, and the concave transparent plate.

Comparing to the circular-cylinder-shaped light-emitting member which is commonly used now, the measure of reflection area of the triangular-prism-shaped light-emitting member 4h is larger in the same length or the same weight condition, and the angle of the reflection surface of the triangular-prism-shaped light-emitting member 4h is more selective to satisfy the requirement of the angle of the light. Therefore, the efficiency of the light increases. And this configuration is suitable for the LED light which is energy-saving and environmental-friendly. Since the light emitted form the point-style LED light source in this configuration can be multiplied so that the intensity and the range of the light also increase.

### The Tenth Embodiment

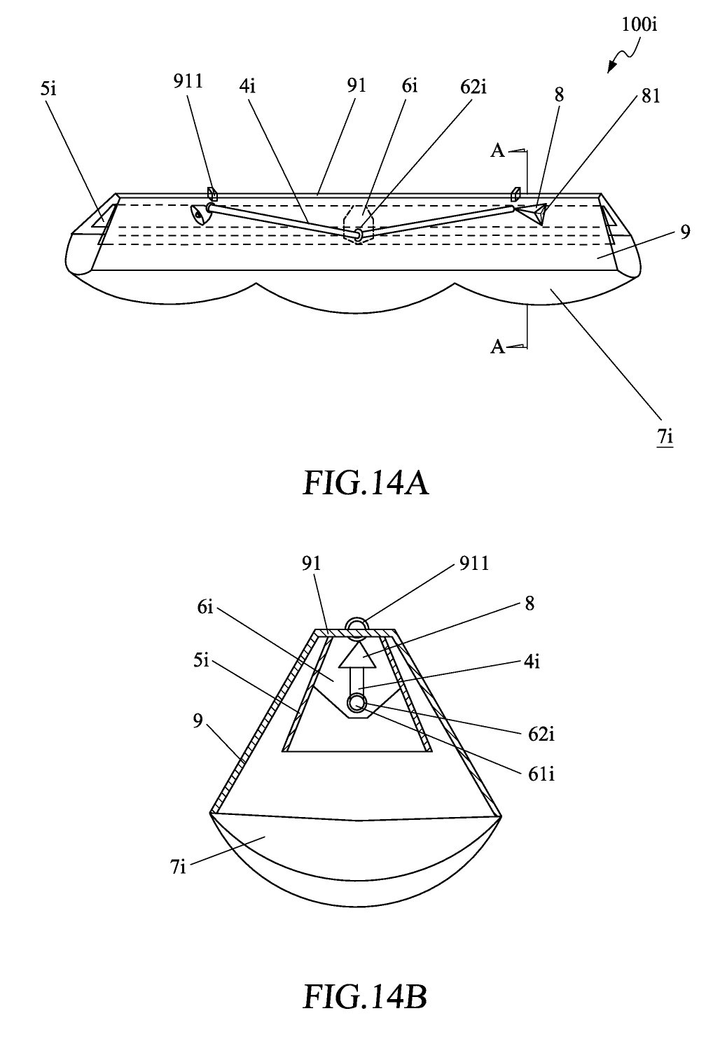

Refer to FIGS. 14A and 14B. A reflective lighting device 100i of the present invention is shown in FIG. 14A. And FIG. 14B shows a sectional perspective view illustrating the A-A direction of the reflective lighting device 100i. The elements of this embodiment illustrated in these two Figs. are similar to those in the fifth embodiment. The tenth embodiment is different from the fifth embodiment in as follows. The light-emitting member 4i is V-shaped. The light-emitting member 4i is arranged within the reflective member 5i and passes through the double-sided mirror 6i which has a punching hole 61i with a rubber ring 62i. An emission lamp 8 is provided on the two ends of the light-emitting member 4i and emits the light slantwise. And the emission lamp 8 has a reflective part 81. In this embodiment, the emission lamp 8 is triangular-pyramid shaped and has a reflection part, wherein the reflective part 81 is a plurality of the reflective mirrors. The emission lamp 8 also may be other polyhedron-shaped, such as pentahedron-shaped, and hexahedron-shaped etc. The advantage of the emission lamp which is made to be the polyhedron-shaped is that the angle of the emission surface of the polyhedron-shaped emission lamp may be designed variously considering the requirement of the emission position. The reflective member 5i is arranged with a reflective trough 9. And the reflective trough 9 is entirely sealed by a waterproof transparent cover 7i. In this embodiment, the waterproof transparent cover 7i is a cover which has three convex arc faces. The waterproof transparent cover 7i may be formed as other configurations shaped to seal the reflective trough 9. A reflective board 91 is disposed on the top of the reflective trough 9, and a fastener 911 is provided on the reflective board 91 for the reflective lighting device 100i being hung on the ceiling. In this embodiment, the reflective member 5i and the reflective trough 9 are both strip-ladder-shaped. The reflective member 5i and the reflective trough 9 also may be formed as other configurations shaped to each other. And the angle of the reflective member 5i and of the reflective trough 9 may be any kinds of the angle as long as smaller than 180°.

As can be appreciated from the above embodiments, the reflective lighting device of the present invention has industry worth which meets the requirement for a patent. The above description should be considered as only the discussion of the preferred embodiments of the present invention. However, a person skilled in the art may make various modifications to the present invention. Those modifications still fall within the spirit and scope defined by the appended claims.

What is claimed is:

1. A reflective lighting device, comprising a light-emitting member, a reflective member and a supporting member, wherein the reflective member includes a reflective plate and a reflective mirror plate, the reflective plate and the reflective mirror plate providing on the supporting member are oppositely facing to each other, and the light-emitting member is provided between the reflective plate and the reflective mirror plate.

2. The reflective lighting device as claimed in claim 1, further comprising a plurality of reflective mirrors provided on the reflective plate and/or on the reflective mirror plate.

3. The reflective lighting device as claimed in claim 1, further comprising a magnifying glass provided on the reflective mirror plate.

4. The reflective lighting device as claimed in claim 1, further comprising a transparent plate extending outward from the reflective mirror plate.

5. The reflective lighting device as claimed in claim 1, further comprising a subsidiary plate provided on the reflective plate.

6. The reflective lighting device as claimed in claim 5, wherein the subsidiary plate has a reflective part and/or a transparent part.

7. The reflective lighting device as claimed in claim 1, wherein the supporting member is a transparent cover.

8. A reflective lighting device, comprising a light-emitting member and a reflective member, wherein the reflective member is provided with a trough shape, the light-emitting member is provided within the reflective member, and a double-sided mirror is arranged within the reflective member.

9. The reflective lighting device as claimed in claim 8, wherein the double-sided mirror is provided with a punching hole thereon for allowing the light-emitting member to pass through, and a rubber ring is put around the punching hole.

10. The reflective lighting device as claimed in claim 8, further comprising a plurality of reflective mirrors provided on the reflective member.

11. The reflective lighting device as claimed in claim 8, further comprising a subsidiary plate, which is provided on the reflective member and has a reflective part and/or a transparent part.

12. The reflective lighting device as claimed in claim 8, a light of a specific wavelength passes through the reflective member, or the reflective member has a transparent part.

13. The reflective lighting device as claimed in claim 8, further comprising a waterproof transparent cover covering the reflective member.

14. The reflective lighting device as claimed in claim 8, wherein the reflective member is a V-shaped configuration or a triangular-prism-shaped configuration.

15. The reflective lighting device as claimed in claim 8, wherein the light-emitting member has a reflective part and/or a transparent part.

16. The reflective lighting device as claimed in claim 8, further comprising an emission lamp provided on the two ends of the light-emitting member.

17. The reflective lighting device as claimed in claim 16, wherein the emission lamp has a reflective part.

18. The reflective lighting device as claimed in claim 16, wherein the emission lamp is a polyhedron-shaped configuration.

19. A reflective lighting device, comprising a light-emitting member and a reflective member, the reflective member is provided with a trough shape, and the light-emitting member is provided within the reflective member, wherein the light-emitting member is a triangular-prism-shaped configuration, and an electrical connector is provided on the light-emitting member.

20. The reflective lighting device as claimed in claim 19, a light of a specific wavelength passes through the surface of the light-emitting member or is reflected from the surface of the light-emitting member, wherein the light-emitting member optionally has a reflective part and/or a transparent part.

21. The reflective lighting device as claimed in claim 1, 8 or 19, wherein the light-emitting member is a LED light, an incandescent light, or a fluorescent light.
